(19) United States
(12) Patent Application Publication
(10) Pub. No.: US 2011/0011836 A1
(43) Pub. Date: Jan. 20, 2011

(54) METHOD AND DEVICE FOR PLASMA KEYHOLE WELDING

(76) Inventor: Gerald Wilhelm, Unterschleissheim (DE)

Correspondence Address: FAY SHARPE LLP, 1228 Euclid Avenue, 5th Floor, The Halle Building, Cleveland, OH, 44115, US

(21) Appl. No.: 12/837,534

(22) Filed: Jul. 16, 2010

(30) Foreign Application Priority Data
Jul. 16, 2009 (DE) 10 2009 027 784.6
Jul. 16, 2009 (DE) 10 2009 027 785.4
Oct. 27, 2009 (EP) 09 013 534.4

(51) Int. Cl. B23K 9/16

(52) U.S. Cl. 219/74

(57) ABSTRACT

In response to plasma keyhole welding of a workpiece, in the case of which a plasma jet is generated using an electrode, to which a welding current is applied, and at least one process gas, wherein at least one gas composition (22) and/or a gas volume flow rate (20, 21) of the process gas is temporally changed, the gas composition (22) and/or a gas volume flow rate (20, 21) of at least one process gas are temporally changed during a welding process as a function of at least one basic condition (E1, E2) of the welding process

The instant invention relates to a method for plasma keyhole welding of a workpiece using at least one process gas, wherein the gas composition and/or at least one gas volume flow rate of the process gas are temporally changed, and to a corresponding device.

Welding refers to the bonding of components by material engagement using heat and/or pressure, if applicable using additional welding materials. Fusion welding methods are used, for the most part, for metals, but also in the case of the welding of glass or for thermoplastic synthetic materials. In the case of fusion welding, welding is typically carried out by means of a locally limited melt flow without using force and thus without pressure. As a rule, the bonding of the components takes place in the form of weld seams or spots.

The gas-shielded arc welding forms one group of welding methods comprising particularly advantageous characteristics, among which the plasma welding takes a special place. The plasma welding is part of the tungsten protective gas (WP) methods, in the case of which a plasma jet serves as heat source. The plasma jet is generated by means of ionization and constriction of an arc, is directed onto a workpiece and is moved along a desired weld seam course, for example. The constriction of the plasma jet to an almost cylindrical gas column (as a rule by means of a water-cooled copper nozzle, mostly with the aid of a so-called focusing gas) results in a higher energy concentration than in the case of conventional welding methods, such as the TIG welding, for example. Up to three gases or gas mixtures can thereby be supplied via concentric nozzles in a plasma burner, which concentrically surrounds the electrode, among them the plasma gas, the focusing gas for constricting the plasma jet and the protective gas. In the case of the common methods, the plasma jet and the focusing gas are enveloped by protective gas. Among others, the use of protective gas serves the purpose of protecting the melt from oxidation during the welding process. The plasma welding is a welding method, in the case of which a constricted arc is used. In the case of plasma welding by means of a transferred arc, the arc burns between the electrode, which does not melt, and the workpiece. By constricting the arc, higher energy densities are reached than in the case of common arc welding comprising a non-melting electrode, the so-called TIG welding.

The plasma keyhole welding represents an alternative of the plasma welding. As a high performance welding method, it allows for the processing of greater sheet thicknesses with small thermal distortion and high welding speeds and is currently mainly used for the joining of chromium-nickel steels by means of welding technology. Today, this technology is furthermore resorted to when particular demands are made on the quality of the weld seam with reference to through-welding, weld shape and weld appearance. As a rule, it is used up to a sheet thickness of 8 to 10 mm. The main areas of application lie in the chemical plant construction, the aerospace industry as well as in the tank and pipeline construction.

In the case of plasma keyhole welding, the plasma jet passes through the entire workpiece thickness at the onset of the welding process. The melting bath, which is created by the melting of the workpieces, is thereby pushed to the side by the plasma jet. The surface tension of the melt prevents a falling through the keyhole. Instead, the melt flows together again downstream from the weld eye, which forms, and solidifies to the weld seam.

In the case of plasma keyhole welding, likewise as in the case of plasma welding, up to three gas flows are used as process gas. The plasma gas is located in the interior. Due to the high energy density in the interior, the plasma gas forms the plasma jet. As a rule, the plasma gas is surrounded by a protective gas, the main object of which is to protect plasma jet and processing location from undesired impacts from the environment. In many cases, a so-called focusing gas is furthermore also used, which supports the constriction and orientation of the plasma jet and which is normally guided between plasma and protective gas.

The process-reliable embodiment of the keyhole is an indispensable requirement for the use of the plasma keyhole welding. Basic requirement for this are an accurate weld edge preparation, which is connected with high requirement of time, and a corresponding positioning of the components as well as the accurate maintaining of the weld parameters. In response to deviations from these basic conditions, e.g. by variable clearances and offsets as well as switches in geometry, which cause a changeable heat conduction into the component, can lead to the insufficient full permeation welding, the formation of spillings, the appearance of undercuts or to the sagging of the weld pool. Exactly in the case of the most commonly welded unalloyed and low-alloyed steels (such as construction steel), these process instabilities appear to in increased extent also due to the high variations of the chemical composition (alloy) as well as due to a low surface tension and viscosity.

The use of the plasma keyhole welding is thus currently possible for the component preparation only with cost and time-intensive efforts. The maximally realizable welding speed further reduces considerably with an increasing sheet thickness; especially the stability of the welding process furthermore also decreases. The difficulty of a stable keyhole embodiment, which dominates in particular in the case of plasma keyhole welding of construction steel, thus currently limits the industrial practicability of the method in this field to a considerable extent.

Different approaches are known to improve a secure and stable embodiment of the keyhole under praxis-relevant conditions, such as, e.g., long arcing times, different sheet surfaces, non-optimal ground connection, fluctuations in the alloy composition and the like.

It is known to pulse the plasma gas in response to the generation of plasma arcs. For instance, EP 257766 A2 discloses a method, in the case of which the plasma gas flow and/or the welding current is modulated to such a high degree that an intermitting perforation of the material or spot welding can be attained.

Optical, pneumatic and/or electric parameters can be monitored during the welding process for the constant control of the keyhole embodiment. For instance, the brightness of the plasma jet passing through, the pressure resulting from its kinetic energy and/or the electric conductivity of its portion escaping on the rear side of the workpiece (so-called permeation current) can be used as control variable for the full permeation welding. The keyhole embodiment is then held so as to be constant over a variation of the welding current. For this, the welding current is mostly adjusted to a basic level and can be raised to an increased value (pulse level), if applicable, so as to supply more energy to the component. However, due to the fact that the thermal load capacity of the plasma gas nozzle limits the maximal welding current, the capability of the plasma burner cannot be used completely in the base current phase, because a “reserve” for the pulse level is to be provided in each case.

To increase the maximal welding speed and/or the maximally weldable sheet thickness, EP 689896 A1 discloses a method, in the case of which the volume flow rate of the plasma gas and thus its energy density is changed periodically at a constant frequency via the mentioned welding process.

JP 08039259 A also contains a method for periodically varying the plasma gas in response to plasma and plasma keyhole welding in pulsed operation.

U.S. Pat. No. 3,484,575 A discloses a periodic change of the composition of the protective gas in response to welding by changing at least one volume flow rate.

DE 102007017223 A1 and DE 102007017224 A1 disclose methods for plasma keyhole welding, wherein a gas mixture is in each case used as plasma gas and/or as protective gas. At least one gas composition or at least one gas volume flow rate, respectively, are temporally changed several times during the welding process, whereby a temporally changing back pressure is exerted onto the melt and said melt is thus oscillated. Through this, the process stability increases in response to the joining of the melt downstream from the keyhole and the kinematics of the keyhole formation is changed advantageously. The energy density of the plasma jet can furthermore be varied by means of the temporally changeable composition or the temporally changeable gas volume flow rate of the focusing gas, respectively.

The instant invention is thus based on the object of providing a method and a device for plasma keyhole welding, by means of which the process stability and handling, in particular the stability of the keyhole embodiment is improved and/or the maximally realizable welding speed is increased.

This object is solved by means of the features of the independent patent claims. Advantageous embodiments result from the respective dependent claims and from the following description.

With reference to the method, the posed object is solved in that, in a method for plasma keyhole welding of a workpiece using at least one process gas, wherein the gas composition and/or at least one gas volume flow rate of the process gas are changed temporally, the gas volume flow rate and/or the gas composition of at least one process gas are temporally changed during a welding process as a function of at least one basic condition of the welding process according to the invention.

In the context of this application, “process gas” (also referred to as “welding gas”) refers to one of the gases used in response to the plasma keyhole welding, such as a plasma gas, a focusing gas and/or a protective gas or forming gas, for example.

A “temporal change” of the gas composition and/or of the gas volume flow rate comprises in particular a gradual, continuous and/or and increase, decrease and/or modulation, which can be described by means of a mathematical function, in particular also a periodic change of a component of a gas composition. The frequency, the phase, the amplitude and/or the base line of a periodically changing gas composition and/or of a periodically changing gas volume flow rate can be varied due to changed basic conditions.

“Workpiece” refers to one or a plurality of elements, in particular metallic elements, which are processed by means of plasma keyhole welding.

A corresponding change can take place in the context of a control cycle or can be input by a user, if applicable on the basis of read indicated values or on the basis of a corresponding signal. The basic conditions can hereby also relate to a plurality of or to all used process gases, that is, they can cause a corresponding temporal changes, but provision can also be made, however, for certain known or measured basic conditions to selective act on individual process gases. It is emphasized in this context that the temporal change during the welding process can be carried out in particular by means of an automatic regulation. The person of skill in the art will clearly define these changes of simple set-up or optimizing processes, respectively, at the onset of a welding process, in the case of which a composition and/or a volume flow rate of a process gas can also be changed and, as a rule, can be adapted once to the weld conditions and to the material.

In the event that the melt is oscillated by adaptation to basic conditions, for example by changing a (periodically modulated) volume flow rate, the process stability increases in a particularly advantageous manner in response to the joining of the melt downstream from the keyhole. By means of the method according to the invention, the kinematics of the keyhole formation is changed (adaptively) in adaptation to the currently available conditions. The maximally realizable welding speed can be increased through this, without significantly increasing the energy input per unit length, that is, the application of energy into the workpiece based on the length of the weld seam, thus causing a smaller distortion of the material, which is to be welded.

Advantageously, the basic conditions comprise characteristics of the workpiece as well as parameters of the welding process, in particular the change thereof. The characteristics of the workpiece can be geometric and/or (physico-)chemical characteristics. Among others, the geometric characteristics include the material thickness, the clearances, deviations in the weld seam preparation and the offset between elements of the workpiece. The chemical characteristics can be alloy or material characteristics (e.g. phases of steel), which impact the welding process.

Advantageously, the parameters of the welding process and/or the characteristics of the workpiece are determined by means of optical, pneumatic and/or electric characteristics of the plasma jet (brightness/pressure or conductivity, respectively). However, it is also possible to determine the characteristics of the focusing gas or of the protective gas or to determine the behavior of the welding process via other parameters, such as, for example, welding stress or characteristics of the melt. In particular in the event that characteristics of the plasma jet change, a reaction can the take place by means of a suitable adaptation of a gas volume flow rate. For instance, the quality of a plasma jet, for example, can be assessed by measuring the permeation current between a workpiece and a forming gas rail, which is affixed therebelow. The volume flow rate of a gas can then be adapted as a function of the measured values. If, for example, the width of a weld gap increases in a predictable or unpredictable manner, a larger portion of the plasma jet passes through the weld gap. The energy quantity available for the welding process decreases, the permeation current increases. In the event that a change is made to a gas volume flow rate on the basis of the detected change of the permeation current, the energy density of the plasma jet can be increased, so that the energy introduced into the workpiece increases. In response to a change of an alloy composition, the keyhole can widen or constrict due to an improved or worse fusibility of the material. Through this, a larger or smaller portion of the plasma jet passes through the keyhole accordingly. The permeation current is increased or decreased. To constrict a keyhole, which is too large, or to widen a keyhole, which is too small, a change of a gas volume flow rate can then be carried out on the basis of the permeation current, whereby the energy density of the plasma jet can be decreased or increased.

A change of the composition of a process gas is possible by means of an increase or decrease of the absolute or relative shares of individual gases of a mixture. For example, a first gas comprising a first, constant volume flow rate and a second gas comprising a second, pulsing volume flow rate can also be provided, whereby the composition of the mixed process gas, which results therefrom, changes accordingly in a pulsing manner. With this, allowances can be made, for example, for changing material compositions. For example, variable mixtures of inert with active process gases can be used, which make it possible to positively impact the welding process in terms of an improvement of the plasma jet quality, the melting deposition rate, the seam surface, the avoidance or limitation of a formation of spillings, of disadvantageous undercut formations or high gas contents in the weld metal deposit. In particular by means of an adaptive change of the composition of the plasma gas, its heat conductivity and its enthalpy can be impacted in consideration of the basic conditions.

Advantageously, the basic conditions comprise characteristics of the workpiece as well as parameters of the welding process, in particular the change thereof. The characteristics of the workpiece can be geometric and/or (physico-)chemical characteristics. Among others, the geometric characteristic include the material thickness, the clearances, deviations in the weld seam preparation and the offset between elements of the workpiece. The chemical characteristics can be alloy or material characteristics (e.g. phases of steel), which impact the welding process. A differentiation can be made between predictable (known) and unpredictable (unknown) changes, which can relate to the geometric as well as to the chemical characteristics. For example, a known, continuous increase of the thickness of the workpiece or of a known change of the material composition by adapting the composition of a gas can cause a particularly stable welding process.

Advantageously, the at least one process gas, the gas volume flow rate of which is temporally changed, comprises a plasma gas, a focusing gas and/or a protective gas. By means of a corresponding modulation of the plasma gas, the energy density of the plasma jet, for example, and thus the energy introduced into the workpiece, can be impacted. The change of the volume flow rate of the focusing gas causes a higher or weaker focusing of the plasma jet and thus also a modulation of the energy density. By impacting the volume flow rate of the protective gas, the protective effect against oxidation can be adapted, provided that this is required, for example due to a larger melting volume or a change of the material composition, and/or the stability of the welding process can be improved. All of the process gasses interact in response to the adjustment of the back pressure to the melt. Said melt can be oscillated by this, for example.

Advantageously, the parameters of the welding process and/or the characteristics of the workpiece are determined by means of optical, pneumatic and/or electric characteristics of the plasma jet. In the event that the characteristics of the plasma jet change, in particular due to unpredictable changes of characteristics of the workpiece, which is to be welded, a reaction can then take place by means of a suitable adaptation of a gas composition. For instance, the quality of a plasma jet, for example, can be assessed by measuring the permeation current between a workpiece and a forming gas rail, which is affixed therebelow. The composition of a gas can then be adapted as a function of the measured values. If, for example, the width of a weld gap increases in a predictable or unpredictable manner, a larger portion of the plasma jet passes through the weld gap. The energy quantity available for the welding process decreases, the permeation current increases. In the event that a change is made to a gas volume flow rate on the basis of the detected change of the permeation current, the energy density of the plasma jet can be increased, so that energy introduced into the workpiece increases. In response to a change of an alloy composition, the keyhole can widen or constrict due to an improved or worse fusibility of the material. Through this, a larger or smaller portion of the plasma jet passes through the keyhole. The permeation current increases or decreases. To constrict a keyhole, which is too large, or to widen a keyhole, which is too small, a change of a gas volume flow rate can then be carried out on the basis of the permeation current, whereby the energy density of the plasma jet can be decreased or increased.

Advantageously, the at least one process gas, the composition of which is temporally changed, comprises a plasma gas, a focusing gas and/or a protective gas. By means of a corresponding modulation of the plasma gas, the energy density of the plasma jet, for example, and thus the energy introduced into the workpiece, can be impacted. The change of the composition of the focusing gas causes a higher or lower focusing of the plasma jet and thus also a modulation of the energy density. By impacting the composition of the protective gas, the protective effect against oxidation can be adapted, provided that this is required, for example due to a larger melt volume or a change of the material composition. All of the process gases interact in response to the adjustment of the back pressure to the melt. Said melt can be oscillated by this, for example.

According to an advantageous embodiment of the invention, at least one of the process gases, in particular the plasma gas, the focusing gas and/or the protective gas encompasses at least one gas from the group of argon, helium, nitrogen, carbon dioxide, oxygen and hydrogen. Gases or gas mixtures, which contain at least one gas from the mentioned group, are accordingly preferably used as plasma gas and/or as focusing gas and/or as protective gas. The determination of the suitable gas or of the suitable gas mixture, respectively, takes place as a function of the weld object, in particular in consideration of the base material, which is to be welded, and possible filler materials, as mentioned above, in adaptively changing compositions.

Advantageously, the clean gases as well as two, three and multi-component mixtures are used. A particularly selective adaptation to the weld object is effected through this.

In many cases, doped gas mixtures can also prove to be particularly advantageous, wherein doped gas mixtures encompass dopings with active gases in the vpm range. Preferably, the doping takes place in the range of less than 2.5, in particular 1.0 volume percent, for the most part less than 0.1 volume percent.

Advantageously, active gases, such as, e.g., oxygen, carbon dioxide, nitrogen monoxide, nitrous oxide (dinitrogen monoxide) or nitrogen can be used.

According to a particularly advantageous embodiment of the invention, the volume flow rate and the composition of at least one process gas, in particular of the plasma gas, the focusing gas and/or the protective gas can be temporally changed. In the event that the melt is oscillated by adaptation to basic conditions, for example by changing a volume flow rate in a pulsing manner, the process stability increases in a particularly advantageous manner when the melt joins downstream from the keyhole. By means of the method according to the invention, the kinematics of the keyhole formation is changed (adaptively) in adaptation to the currently available conditions. In the event that a gas volume flow rate is provided in a pulsing manner, a pulsing of the plasma jet can be effected. Through this, the maximally realizable welding speed can be increased without significantly increasing the energy input per unit length, that is, the application of energy into the workpiece based on the length of the weld seam, thus causing a smaller distortion of the material, which is to be welded. A change of the composition of a process gas is possible by means of an increase or decrease of the absolute or relative shares of individual gases of a mixture. For example, a first gas comprising a first, constant volume flow rate and a second gas comprising a second, pulsing volume flow rate can also be provided, whereby the composition of the mixed process gas, which results therefrom, changes accordingly in a pulsing manner. With this, allowances can be made, for example, for changing material compositions. For example, variable mixtures of inert with active process gases can be used, which make it possible to positively impact the welding process in terms of an improvement of the plasma jet quality, the melting deposition rate, the seam surface, the avoidance or limitation of a formation or of spillings, of disadvantageous undercut formation of high gas contents in the weld metal. In particular by means of an adaptive change of the composition of the plasma gas, its heat conductivity and its enthalpy can be impacted in consideration of the basic conditions.

It is pointed out here that the simplest possibility for changing a gas volume flow rate is to either change the flow or to turn on or turn off, respectively, a second gas flow comprising the same gas composition. Accordingly, the gas composition can be changed by mixing different gases, which are provided in volume flow rates, which are temporally changeable to one another. A change of a gas composition can be accompanies by a volume flow rate change when a different gas is turned on, for example.

Advantageously, the welding current is furthermore temporally changed, in particular it is welded with pulsed current. A welding with a direct or alternating current is also possible. By means of a corresponding change, in particular by adaptation to the mentioned basic conditions, an additionally improved adaptation to the weld object can be effected by impacting the application of energy.

A further advantageous embodiment of the invention hereby provides for a welding to be carried out by means of pulsing welding current (pulsed current), wherein each period is comprised of a pulsed current phase (high current phase) and a base current phase (low current phase). A welding current, which is provided in a pulsed manner, increases the process reliability in addition to the mentioned measures.

According to an advantageous development, the mentioned temporal changes of the gas volume flow rate, of the composition of at least one process gas and/or of the welding current are carried out so as to be tuned to one another. Preferably, a temporal change of the gas composition, of a gas volume flow rate of at least one process gas and/or of the welding current takes place as a function of at least one further temporal change of a gas composition, of a volume flow rate and/or of a welding current.

It is to be insinuated that a change “as a function of at least one further temporal change” can include a change, which is in-phase, phase-shifted, rectified or directed oppositely, provided that this is advantageous.

In the case of welding by means of pulsing welding current (pulsed current), the plasma gas volume flow rate, the focusing gas volume flow rate and/or the protective gas volume flow rate, for instance, can be temporally changed synchronously or phase-shifted to the course of the pulsed current, whereby an adaptation to the respective energy, which is introduced into the material, can take place. In addition to the volume flow rate change, a corresponding composition change can also take place. And, vice versa, in addition to a composition change, a corresponding volume flow rate change can also take place.

Provision can further be made, for example, for the focusing gas to be changed synchronously to at least a further provided process gas, in particular synchronously to the plasma gas (the gas volume flow rate on its part is impacted by basic conditions). This serves, in particular, to prevent turbulences and possible disadvantageous mixing between plasma gas and focusing gas. By means of a corresponding change, the energy density of the plasma jet can be varied in a particularly advantageous manner, in that its focusing is changed adaptively.

In an analogous manner, the gas volume flow rate of the protective gas, for example, can be changed temporally as a function of the gas volume flow rate of the plasma gas and/or of the focusing gas. In addition to the mentioned prevention of turbulences, the protective gas can be provided so as to be adapted to the remaining volume flow rates by changing the volume flow rate thereof.

The change of the composition can take place in an advantageous embodiment synchronously to the change of the gas volume flow rate. In other cases, however, it can also be advantageous to change gas volume flow rate and compositions in a phase-shifted manner to one another. It is also possible to pulse gas volume flow rate and composition comprising different frequencies.

Advantageously, the temporal change of the gas composition, of a volume flow rate of at least one process gas and/or of the welding current takes place periodically at a frequency in the range of between 1 and 200 Hz, in particular between 12 and 200 Hz, in particular between 15 and 100 Hz, preferably between 20 and 80 Hz. The temporal change (according to the invention) as a function of a basic condition then takes place in the form of a change of this frequency (or also of the amplitude, of the phase or of the base line). The advantages of the invention also present themselves in a distinctive manner up to frequencies of 200 Hz, particularly distinctive up to 100 Hz and in particular up to 80 Hz. It turned out in particular for the plasma gas that the plasma contracts almost continuously due to its inertia in the case of frequencies, which lie above the afore-mentioned lower limits. The contraction leads to an increase of the energy density and, as a result, to an increase of the sheet thickness, which can be welded, or to an increase of the maximum welding speed, without significantly increasing the energy input per unit length.

In an advantageous development, the modulation comprising the afore-mentioned (low) frequencies is superimposed with a further, high-frequency pulse comprising a frequency of up to 10000 Hz, preferably of up to 80000 Hz. This can either be a pure volume pulsing, but provision can also be made for a corresponding pulsing of the composition or a combined pulsing of volumes and composition. Advantageously, however, only a high-frequency pulsing of the gas volume flow rate takes place in addition to the low-frequency pulsing. Plasma gas and/or focusing gas and/or protective gas can be affected by the additional high-frequency pulsing. This additional high-frequency pulsing can take place during the entire period of the (low-frequency) pulsing or only during a certain time period within the period. The frequencies for the high-frequency pulsing of the gas volume flow rate and/or of the gas composition lie in the range of from 100 to 10000 Hz, preferably in the range of from 250 to 8000 Hz and particularly preferably in the range of from 500 to 5000 Hz. For example, a low-frequency gas volume flow rate of the plasma and/or of the focusing gas can be superimposed in a particularly advantageous manner on a low-frequency gas volume flow rate of the plasma and/or of the focusing gas in the high phase and/or in the low phase. A corresponding superimposition can advantageously also take place so as to be adapted to changing basic welding conditions.

Advantageously, the temporal change of gas volume flow rate, of a composition of at least one process gas and/or of the welding current is at least partly illustrated by means of a rectangle profile. In a particularly advantageous manner, the temporal change runs according to a modified rectangle profile, which encompasses slanted shoulders. Another advantageous embodiment of the invention provides for the temporal change of the volume flow rate and/or of the composition to be illustrated at least partly by means of a triangle profile or a sinusoidal profile.

A device according to the invention for plasma keyhole welding, which encompasses an electrode, means for supplying the electrode with welding current, at least one nozzle and gas provision means for providing at least one process gas with a gas volume flow rate and a gas composition, wherein a plasma jet can be generated by means of the electrode and the at least one process gas and wherein at least one gas volume flow rate and/or at least one gas composition can be temporally changed, characterized by means for changing a gas volume flow rate and/or a gas composition of at least one process gas during a welding process as a function of at least one basic condition of the welding process.

The device according to the invention is suitable for carrying out the method according to the invention in a particular manner. The means for changing the gas volume flow rate can thereby in particular be magnetic valves or piezoelectric valves or corresponding pumps or mixers, which operate in a pulsed manner.

The welding process can be optimized in a particularly advantageous manner in an object-specific manner by suitably selecting the combination possibilities of the embodiments according to the invention.

Advantageously, a corresponding device further encompasses means for determining basic conditions and/or basic condition changes of the welding process and/or means for regulating at least one gas composition on the basis of such basic conditions and/or basic condition changes. Advantageously, a corresponding device further encompasses means for determining basic conditions and/or basic condition changes of the welding process and/or means for regulating at least one gas volume flow rate on the basis of such basic conditions and/or basic condition changes. Equipment, which is already present in the device, for example those for optically, pneumatically and/or electrically assessing the plasma jet, can serve as means for determining basic conditions. In particular the means for regulating can thereby be a part of a superordinate regulating device or of a corresponding arithmetic unit.

With reference to further features, embodiments and advantages of the device according to the invention, reference is made expressly to the explanations with reference to the method according to the invention.

The invention as well as further embodiments of the invention will be defined in more detail below by means of the exemplary embodiments illustrated in the figures. In detail:

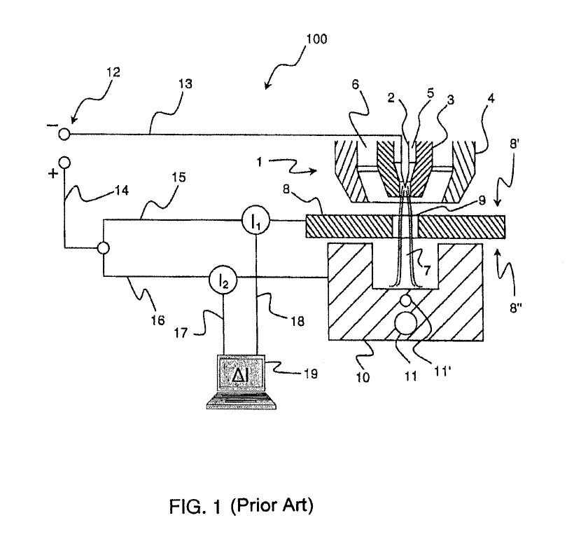

FIG. 1 shows a schematic illustration of a device for plasma keyhole welding according to the state of the art and

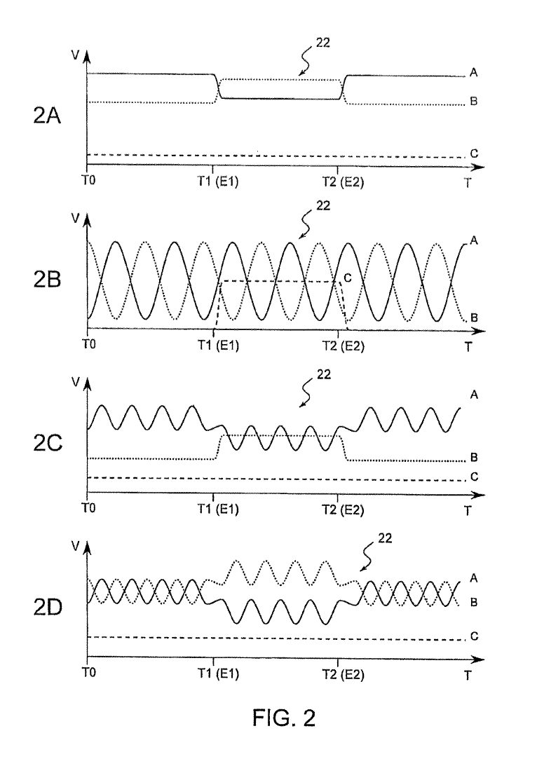

FIG. 2 shows examples for a temporal change of gas volume flow rates as a function of basic conditions according to a particularly preferred embodiment of the instant invention,

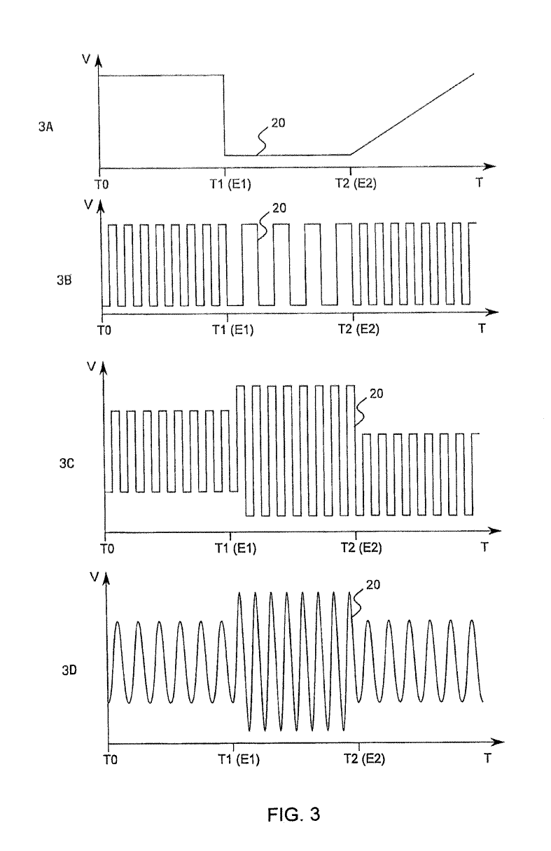

FIG. 3 shows examples for a temporal change of gas volume flow rates as a function of basic conditions according to a particularly preferred embodiment of the instant invention and

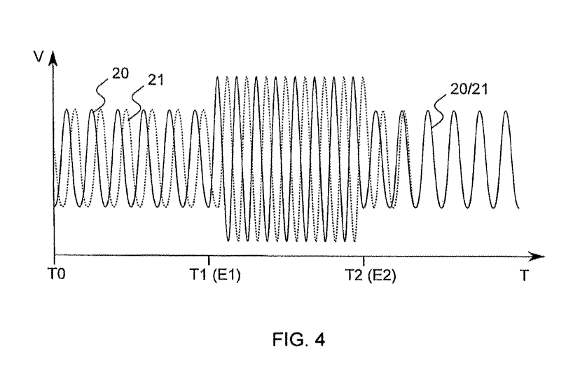

FIG. 4 shows a further example for a temporal change of gas volume flow rates as a function of basic conditions according to a particularly preferred embodiment of the instant invention.

A device for plasma keyhole welding according to the state of the art is illustrated in FIG. 1 and is identified as a whole with 100. The device has a blowpipe 1, which is oriented onto a workpiece 8. The blowpipe 1 encompasses an electrode 2, preferably a non-burning or non-melting tungsten electrode 2, which is connected to the negative pole of a welding current source 12 via lines 13. The electrode 2 is surrounded by a first nozzle 3, in the lumen 5 of which a plasma gas comprising a volume flow rate and a composition is provided. Burner 1 encompasses a further nozzle 4, which surrounds the first nozzle and the electrode in a concentric manner and in the lumen 6 of which a further process gas, for example a focusing gas and/or a protective gas comprising a further volume flow rate and a further composition can be provided. Provision can be made for further nozzles, in which further process gases can be provided, but they are not illustrated to simplify manners.

A plasma jet 7 forms under the impact of the stress on the electrode 2 in the presence of the plasma gas 5. It is illustrated in the figure, how the plasma jet 7 permeates through the workpiece 8 through a keyhole 9 from an inlet 8′ in the direction of an outlet side 8″. Provision is made on the outlet side 8″ of the plasma jet 7 for an electric conductor 10, which is not defined in detail, which can be embodied as part of a forming gas rail. Ducts 11, 11′, which are ducts for water cooling and/or for ducts by means of which a protective gas or a corresponding further process gas can be provided, are embodied in the electric conductor 10 and/or in the corresponding forming gas rail. The electric conductor 10 is connected to the positive pole of the welding current source 12 via lines 14 and 16, the workpiece 8 via lines 14 and 15.

A measuring or evaluation unit 19, symbolized herein as a computer, which measures the currents I₁ and I₂ between the electrode 2 and the workpiece 8 or the conductor 10, respectively, via measuring lines 17 and 18, is furthermore illustrated in FIG. 1. The current flow I₂ is referred to as permeation current, which is variable as a function of changeable process variables. The permeation current can be used in a particularly preferred manner as an indicator for changeable basic conditions of the welding process.

In the partial FIGS. 2A to 2D of FIG. 2, the time (T) is in each case plotted on the X-coordinate and the size of a gas volume flow rate (V) is plotted on the ordinate, for example in liters per second. Temporal courses of gas compositions 22 of process gases according to particularly preferred embodiments of the invention are illustrated in all partial figures. The gas compositions 22 encompass in each case three gas components A, B and C, which together result in a mixed gas. It is understood that provision can also be made in addition to three gas components for any other number, without leaving the scope of the invention and that in addition to clean gases, gas mixtures can also be used as gas components. At least one of the components A, B, C can also be comprised of a plurality of gas flows, whereby the total gas volume flow rate of the components can be changed by turning on or turning off, respectively, a corresponding gas flow. The specified curves are hereby not to be considered as being true to scale. A basic condition change E1 and E2, which is disclosed to the system in a suitable manner, also takes place in all partial figures at certain points in time T1 and T2. However, it is to be insinuated that, in addition to a corresponding basic condition change E1 or E2, respectively, at the points in time T1 or T2, respectively, the provision of corresponding other signals can also take place, which lead to a change of the gas composition in a comparable manner. For example, a basic condition E1 can impact a first gas, for example the plasma gas, at a first pint in time T1, for example, whereupon a corresponding change of a second gas is then initiated, which is inferred from the first change. It is further understood that commands of a corresponding temporally running welding program, for example, can also be processed at the points in time T1 or T2, respectively.

FIG. 2A shows the temporal course of a gas composition 22, which is provided in a non-pulsed (continuous) manner. Starting at the point in time T0 (for example starting at the onset of the welding process), the gas composition encompasses a first gas composition, wherein gas component A encompasses the highest concentration, the highest volume flow rate or the highest partial pressure (referred to as share hereinbelow). In the event that a first basic condition change E1 is detected at a first point in time T1 or in the event that the system receives another corresponding signal, which characterizes a narrowing of the weld gap or a decrease of the permeation current, for example, it can be effected that the share of this gas A is decreased. The share of the gas B, however, is increased. By means of a corresponding decrease of a gas, which is more difficult to ionize, for example, as compared to a gas, which can be ionized easier, a higher energy density of the plasma jet can be effected in the plasma gas, whereas a change in reverse direction leads to a corresponding decrease. The third component C, for example a doping gas, remains on the same level. In the event that a further change E2 takes place at a second point in time T2, the system returns into the initial state, wherein the share of component A is raised again and the share of component B is reduced. The total volume flow rate of the gas mixture and thus of the back pressure exerted on the melt by means of the process gas, does not change in FIG. 2A.

It is shown in FIG. 2B how the shares of two gas components A and B in each case change with a sinusoidal course. The phases of the curves are offset by 180°, thus causing a pulsing change of composition. A basic condition change E1 is recognized at the point in time T1 analogously to the previous figure. As a result, a third gas component C, which previously had not been a part of the gas mixture, is now turned on. As above, the system returns into the initial state at the point in time T2. In the context of FIG. 2B, the total volume flow rate increases between point in time T1 and T2 by the share of the gas C. An increased back pressure can be effected through this, for example.

A gas component A is continuously pulsed with a sinusoidal course in FIG. 2C. A gas component C remains constant. The share of a Gas B is increased between T1 and T2; a basic pressure of the component A is lowered at the same time (for example by turning off a continuous gas source). The difference between maximum and minimum volume flow rate of the gas A, however, does not change. The total back pressure of the composition 22 (except for the continuous pulsing) is not changed therewith.

In a similar manner, FIG. 2D shows a reduction of a pulsed component A between the points in time T1 and T2 and an increase of a pulsed component B, so as to not considerably change the total back pressure.

It is to be insinuated that, even though frequencies, which are not superimposed, are illustrated in FIG. 2 in each case, a superimposition of the corresponding curves, in particular with high-frequency pulses, can take place in any manner without deviating from the invention. Provision can likewise be made to superimpose the wave form with any further functions. The forms for the respective courses of plasma, focusing and protective gas volume flow rate are only specified schematically in the partial figures of FIG. 2 and are to be considered as examples. They can encompass rise rates, drop rates, intermediate pulses and shoulders (e.g. in the case of change-overs), which allow for the object-specific requirements of concrete weld objects.

In the partial FIGS. 3A to 3D of FIG. 3, the time (T) is in each case plotted on the X-coordinate and the size of a volume flow (V) is plotted on the ordinate, for example in liters per second. Temporal courses of volume flow rates 20 are illustrated in all partial figures according to particularly preferred embodiments of the invention. The volume flow rates 20 hereby refer in particular optionally to the temporal change of the volume flow rates of plasma, focusing and protective gas. A change of basic conditions E1 or E2, respectively, which is disclosed to the system in a suitable manner, also takes place in all partial figures at certain points in time T1 and T2. However, it is to be insinuated that, in addition to a corresponding basic condition change E1 or E2, respectively, at the points in time T1 or T2, respectively, the provision of corresponding other signals can also take place, which lead to a change of the gas volume flow rate in a comparable manner. For example, a basic condition El can impact a first gas, for example the plasma gas, at a first pint in time T1, for example, whereupon, at the point in time T2, a corresponding (same or different) change with reference to a second process gas is then initiated, which is based on the first basic condition and which is inferred from the first change. It is further understood that commands of a corresponding temporally running welding program can also be processed at the points in time T1 or T2, respectively.

FIG. 3A shows the temporal course of a gas volume flow rate 20, which is provided in a non-pulsed (continuous) manner. The volume flow rate 20 initially runs at a high level between point in time T0 and T1. In the event that a first basic condition change E1 is detected at a first point in time T1 or in the event that the system receives another corresponding signal, which characterizes a narrowing of the weld gap or a decrease of the permeation current, for example, it can be effected that the gas volume flow rate, for example the gas volume flow rate of the plasma gas, is decreased to a lower level. In the event that a further change E2 takes place at a second point in time T2, it can now be effected, for example, that the corresponding gas volume flow rate slowly and continuously returns to its original level. By means of this change in the form of a continuous increase, a continuously increasing material thickness can be complied with, for example.

It is shown in FIG. 3B how a course of a gas volume flow rate 20, which follows a rectangle profile, is changed at a point in time T1 (corresponding to a basic condition change E1) with reference to its frequency. After a determination of a further change of the basic conditions E2 at the point in time T2, the system returns to the original course of the gas volume flow rate 20. A different frequency of the vibrations in the weld bath can be effected by this, by means of which viscosity changes can be compensated for.

FIG. 3C shows in an analogous manner, how a rectangle signal of a gas volume flow rate 20 is changed at a first point in time T1 (corresponding to E1) with reference to its amplitude, for example so as to effect a stronger vibration. At a second point in time T2 (corresponding to E2), the amplitude is then decreased to the original level, wherein a base line offset is furthermore illustrated in the figure. This can be effected, for example, by turning off a continuously operating gas source, whereby the total back pressure onto the melt can be decreased.

In a similar manner, FIG. 3D shows an increase of the amplitude and a simultaneous increase of the frequency of a corresponding sinusoidal signal of a gas volume flow rate 20 at the point in time T1 and T2.

FIG. 4 shows two sinusoidal signals of gas volume flow rates 20, 21 of corresponding different process gases, for example of the plasma gas on the one hand and of the focusing gas on the other hand. Between the points in time T0 and T1, the signals 20 and 21 are phase-shifted by approximately 120°. The amplitude and simultaneously the frequency of both gas volume flow rates 20 and 21 is increased due to a change of one or a plurality of basic conditions E1, which is detected at the point in time T1. In addition, a shifting of the phases, which are now offset relative to one another by 180°, takes place. A basic condition change E2 is determined again at the point in time T2. Frequency, amplitude and phases of the signals 20 and 21 are changed again. In the exemplary illustration of FIG. 4, starting at the point in time T2, the signals of the gas volume flow rates 20 and 21 run in-phase and with the same frequency and amplitude after a build-up phase.

It is to be insinuated that, even though FIGS. 3 and 4 in each case do not illustrate superimposed frequencies, a superimposition of the corresponding curves, in particular with high-frequency pulses, can take place in any manner, without deviating from the invention. Provision can likewise be made to superimpose the wave form with any further functions. The forms for the respective courses of plasma, focusing and protective gas volume flow rate are only specified schematically in the partial figures of FIGS. 3 and 4 and are to be considered as examples. They can encompass rise rates, drop rates, intermediate pulses and shoulders (e.g. in the case of change-overs), which allow for the object-specific requirements of concrete weld objects.

1. A method for plasma keyhole welding of a workpiece using at least one process gas, wherein the gas composition (22) and/or at least one gas volume flow rate (20, 21) of the process gas are temporally changed, wherein the gas volume flow rate (20, 21) and/or the gas composition (22) of at least one process gas are temporally changed during a welding process as a function of at least one basic condition (E1, E2) of the welding process.

2. The method according to claim 1, wherein characteristics of the workpiece and/or parameters of the welding process are used as basic conditions.

3. The method according to claim 2, wherein the parameters of the welding process and/or the characteristics of the workpiece are determined by means of optical, pneumatic and/or electric characteristics of the plasma jet.

4. The method according to claim 1, wherein at least one process gas is used, which encompasses a gas, which is chosen from the group consisting of argon, helium, nitrogen, carbon dioxide, oxygen and hydrogen.

5. The method according to claim 1, wherein at least one process gas is used, which is a clean gas or a gas mixture of two, three or a plurality of gases.

6. The method according to claim 1, wherein at least one process gas is used, which encompasses a doping gas in a volume portion of less than 2.5, in particular of less than 1.0 volume percent, in particular in a volume portion of less than 0.1 volume percent.

7. The method according to claim 1, wherein at least one process gas is used, which encompasses a doping gas, which is chosen from the group consisting of oxygen, carbon dioxide, nitrogen monoxide, dinitrogen monoxide or nitrogen.

8. The method according to claim 1, wherein welding is carried out by means of pulse current.

9. The method according to claim 1, wherein the welding current is further temporally changed.

10. The method according to claim 1, wherein a temporal change of the gas composition (22), of a volume flow rate of at least one process gas and/or of the welding current is carried out as a function of at least one further temporal change of a gas volume flow rate, of a composition and/or of a welding current.

11. The method according to claim 1, wherein the gas volume flow rate (20, 21) and/or a composition of at least one process gas is modulated periodically at a frequency of between 1 and 200 Hz.

12. The method according to claim 11, wherein the temporal periodic modulation is superimposed with an additional temporally periodical modulation comprising a frequency of up to 10000 Hz, preferably of up to 8000 Hz.

13. A device for plasma keyhole welding, which encompasses an electrode, means for supplying the electrode with welding current, at least one nozzle and gas provision means for providing at least one process gas with a gas volume flow rate and a gas composition, wherein a plasma jet can be generated by means of the electrode and the at least one process gas and wherein at least one gas volume flow rate (20, 21) and/or at least one gas composition can be temporally changed, wherein means are provided for changing a gas volume flow rate (20, 21) and/or a gas composition of at least one process gas during a welding process as a function of at least one basic condition (E1, E2) of the welding process.

14. The device according to claim 13, which further encompasses means for determining basic conditions (E1, E2) and/or basic condition changes (E1, E2) of the welding process.

15. The device according to claim 13, which further encompasses means for regulating at least one gas composition (22) and/or a gas volume flow rate (20, 21) on the basis of basic conditions (E1, E2) and/or basic condition changes (E1, E2) of the welding process.

16. The method according to claim 1, wherein the gas volume flow rate (20, 21) and/or a composition of at least one process gas is modulated periodically at a frequency of between 12 and 200 Hz.

17. The method according to claim 1, wherein the gas volume flow rate (20, 21) and/or a composition of at least one process gas is modulated periodically at a frequency of between 15 and 100 Hz.

18. The method according to claim 1, wherein the gas volume flow rate (20, 21) and/or a composition of at least one process gas is modulated periodically at a frequency of between 20 and 80 Hz.
